(19) United States
(12) Patent Application Publication
(10) Pub. No.: US 2026/0193132 A1
(43) Pub. Date: Jul. 9, 2026

(54) Process for recovering plaster waste and installation for carrying out such a process

(71) Applicant: HOLDING RITLENG, Rohr (FR)

(72) Inventors: Jean-Luc RITLENG, Rohr (FR); Geoffrey RITLENG, Rohr (FR); Arnaud RITLENG, Rohr (FR)

(21) Appl. No.: 19/130,910

(22) PCT Filed: Nov. 16, 2023
(86) PCT No.: PCT/EP2023/082059

§ 371 Date: May 16, 2025

(30) Foreign Application Priority Data
Nov. 16, 2022 (FR) FR2211922

(51) Int. Cl. C04B 11/05; C01B 3/22; C04B 11/028

(52) U.S. Cl. CPC C04B 11/05; C01B 3/22; C04B 11/028; C01B 2203/0838; C01B 2203/1205

(57) ABSTRACT

A process for recycling plaster waste from the general public, the process comprises a step (S1) for sorting the solid waste in order to obtain a portion (A) known as gypsum, and a portion (B) known as reject; a step (S2) of generating fuel from at least part of the portion (B) of rejects by an exothermic process; a step (S3) for generating anhydrite from at least part of the gypsum portion (A); the process further comprising the recovery of at least part of the heat (C) generated by the exothermic process, in that the step (S3) of generating anhydrite comprises the heating of the at least part of the portion (A) of gypsum produced from the at least part of the heat (C).

### FIELD OF THE INVENTION

This invention relates to the field of waste recovery, and more specifically to the field of gypsum waste recovery.

More specifically, the invention relates to a process and an installation for increasing the recovery of gypsum waste.

### TECHNOLOGICAL BACKGROUND

Plaster is a hydraulic binder typically obtained from gypsum, a naturally occurring material mined in quarries.

Plaster waste from the general public comes from a variety of sources, and is often intimately mixed with other materials. Examples include:
simple plaster, for example any plasterboard consisting of gypsum covered with a paper facing,
plaster tiles
plaster moulds,
plaster from ceilings mixed with linen, reeds, wood lath, etc.
complex plaster, covered with glass wool, rock wool, polystyrene, etc.
plaster covered with earthenware, metal, plastic, electrical insulators, etc.

Operating costs, environmental issues and the depletion of resources have led to the development of solutions for recycling plaster waste to recover gypsum. Recycling plaster waste involves successive stages of crushing and sorting to separate the gypsum from other waste, which may include metal, wood, polystyrene, paper and cardboard.

The recycled gypsum can then be recovered for use in the manufacture of plaster, or transported and sent to processing centres to be transformed into anhydrite, which is used as an input in agriculture.

Other waste must then be treated. In general, they are then transported to a site other than the recycling site, where specific treatment facilities are provided.

The transport and treatment of other waste thus pose problems in terms of environment and recovery.

What's more, recycling plaster waste and processing the waste are energy-consuming operations, which entail additional costs and therefore reduce the recovery of plaster waste.

The aim of the invention is to provide an environmentally-friendly solution to the treatment of gypsum waste, in particular by increasing its recovery and recycling.

### SUMMARY OF THE INVENTION

Thus, according to a first aspect, the invention relates to a process for recovering plaster waste from the general public, the process comprising:
A step of crushing and sorting the solid waste in order to obtain at least one portion known as the gypsum portion, the majority of which comprises gypsum, and a portion known as the reject portion, the majority of which comprises any material other than gypsum, the reject portion comprising at least some organic matter;
A step of generating fuel from at least part of the reject portion by an exothermic process;
A step of generating anhydrite from at least part of the gypsum portion.

The process also includes recovering at least some of the heat generated by the exothermic process. The anhydrite generation step then comprises heating the at least part of the gypsum portion, and said heating is carried out using the at least part of the heat recovered during fuel generation in order to use it for heating the gypsum portion.

Thanks to these provisions in particular, the process makes it possible to improve the recovery of gypsum waste. In this case, the waste from the gypsum recycling stage is transformed directly to produce electrical energy, and this transformation is also used to recover heat and use it to transform gypsum into anhydrite. In this way, the process limits the need for external energy inputs, reducing the costs of implementation and therefore production, particularly of anhydrite.

According to different aspects, it is possible to provide for one and/or the other of the following arrangements either singly or in combination.

In one embodiment, the fuel generation step may comprise a gasification step, so that the fuel produced is gaseous. It can then be easily stored and used on demand to generate electricity, for example.

In one embodiment, at least some of the fuel can be used in an electrical energy system to supply an electrical network. This electrical network may be the one supplying the recovery process, and/or an industrial network and/or a city network. The electrical energy produced can then be sold, increasing the recovery of gypsum waste.

In one embodiment, at least some of the recovered heat can be used in the fuel generation stage. The fuel generation stage can include endothermic reactions, although it is generally exothermic. By injecting some of the heat produced during the fuel generation stage into this stage, it is self-sustaining, requiring no external energy input.

In one embodiment, the reject portion may comprise at least some paper or cardboard. These materials are commonly found together with plaster in building demolition waste in particular. They can therefore be recycled in the fuel generation stage.

In one embodiment, the anhydrite generation step comprises, after heating, grinding the anhydrite to a predetermined particle size. Anhydrite can therefore be supplied to buyers according to their needs and requirements. For example, the particle size can be determined as a function of a required final shape and/or the requirements for mixing with other components according to a recipe, for example for soil conditioning. The recovering process enables anhydrite to be delivered directly in the form required by a buyer.

In one embodiment, the recovering process can include the recovery of residual heat remaining after the heating of the anhydrite generation stage, so as to increase the yield of the process.

According to a second aspect, the invention relates to a plant for recovering plaster waste from the general public for implementing the process as presented above, the plant comprising:
at least one waste crushing and sorting station in order to obtain at least one portion known as gypsum, the majority of which comprises gypsum, and a portion known as reject, the majority of which comprises any material other than gypsum, the reject portion comprising at least some organic matter;
at least one conversion station for generating fuel from at least part of the reject portion by an exothermic process;
at least one anhydrite station for generating anhydrite from at least part of the gypsum portion.

In addition, the anhydrite station comprises at least one heating device and the installation further comprises at least one heat exchange module between the transformation station and the heating device.

The installation thus formed ensures a high level of recovery of all the gypsum waste by treating both the gypsum portion and the reject portion from the crushing and sorting stage.

In one embodiment, the conversion station can include at least one gasification reactor for converting the reject portion into gaseous fuel.

In one embodiment, the at least one reactor is, for example, a co-current fixed bed reactor. This technology is particularly well-suited to treating the reject portion of gypsum waste.

In one embodiment, the anhydrite station can also include at least one crusher downstream of the heating device, in order to crush the anhydrite obtained to a particle size determined by the purchasers'requirements.

In one embodiment, the transformation station for fuel generation and the anhydrite station can be located on the same site. The heat recovered in the transformation station for fuel generation can then be injected into the anhydrite station with high efficiency, as the distance to be covered is limited. All the facilities needed for high-grade recovery of plaster waste can be installed on a single site. Waste, of no value in its raw state, is supplied to the site, while high-value energy and anhydrite are recovered from the site.

### BRIEF DESCRIPTION OF THE DRAWINGS

Embodiments of the invention will be described below while referring to the drawings, briefly described below:

FIG. 1 schematically illustrates the stages of a process for recovering gypsum waste according to an embodiment of the invention.

FIG. 2 shows a schematic view of a waste recovery plant as seen from above, according to one embodiment

FIG. 3 schematically shows a processing station for obtaining gaseous fuel in one embodiment.

FIG. 4 shows a schematic diagram of an anhydrite plant in one embodiment.

FIG. 5 shows schematically a site on which an anhydrite plant in one embodiment and a conversion plant for generating fuel are installed.

In the drawings, identical numbers refer to identical or similar objects.

### DETAILED DESCRIPTION

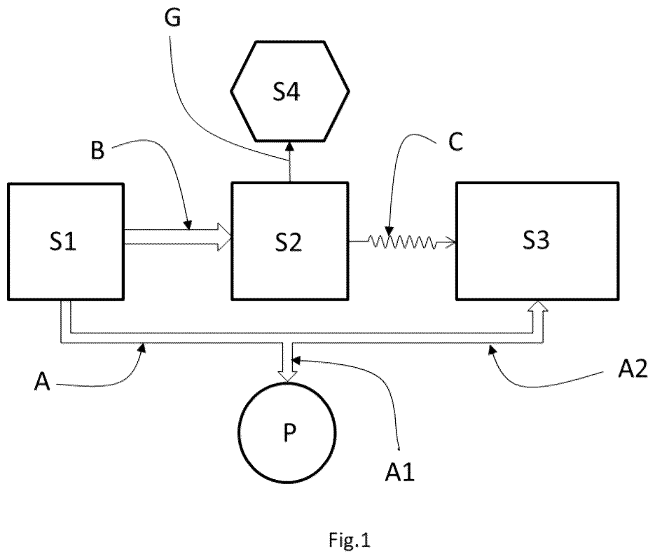

FIG. 1 shows schematically a process for recycling plaster waste from the general public, which is mixed with other materials.

In a preliminary sorting step (S1), the waste is sorted to obtain a gypsum portion (A) and a reject portion (B). For example, sorting step S1 may typically comprise one or more crushing operations prior to or alternating with one or more sieving operations. The gypsum portion A comprises a majority of gypsum, i.e. more than 50% by mass of gypsum, or even more than 70% and even more preferably at least 90% by mass of gypsum. The reject portion B is therefore low in gypsum. Given the origin of the gypsum waste, the reject portion comprises organic material, or biomass, for example paper and/or cardboard and/or wood, and may comprise various other materials, for example metal, brick, polystyrene or nylon. This first stage S1 is, for example, a gypsum recycling stage, examples of which are known.

At the end of the sorting stage S1, the reject portion B is used, at least in part and preferably entirely, in a fuel G generation stage S2. This step S2 involves a generally exothermic process, so that the fuel G generated is at a temperature higher than the ambient temperature. Specifically, fuel G generation step S2 may involve endothermic reactions, but the result is an exothermic process.

For example, the exothermic process includes gasification, so that the fuel G generated is gaseous. To this end, the reject portion B may undergo pre-treatment before the generation step S2, for example in order to sort the organic matter from the other materials, and/or in order to control the particle size, and/or in order to increase the density of the matter in the reject portion B so that it can be presented in a particular form, such as briquettes or pellets. The reject portion B, whether pre-treated or not, can then be fed into the gasification process. For example, the gasification process may comprise:
a drying phase;
a pyrolysis phase in an atmosphere low in oxidising agents, during which volatile substances such as carbon monoxide, carbon dioxide, hydrogen, methane, water vapour and gaseous hydrocarbons, as well as coal, are produced;
an at least partial oxidation phase, in which, in an atmosphere enriched with an oxidising agent, for example air, and/or oxygen, and/or steam, on the one hand the volatile substances are oxidised, and on the other hand the gaseous hydrocarbons are destroyed by thermal cracking;
a gasification phase, involving reduction and combustion reactions, during which the coal is converted into a gas known as “syngas”, a fuel rich in carbon monoxide and dihydrogen in particular.

The order of these phases, and whether or not they are present, may follow the above presentation, but not necessarily.

The exothermic process therefore produces heat C which can be recovered at least in part and used, for example, to sustain any endothermic reactions in the gaseous fuel generation stage S2. As will be seen later, at least some of the heat C is recovered for use in a subsequent stage of the recovery process. According to the example of the gaseous fuel generation process presented below, the partial oxidation phase is exothermic.

As will be seen later, all the phases of gaseous fuel generation can take place in the same reactor, or in separate enclosures.

At the end of sorting stage S1, the gypsum portion A is sent at least in part to an anhydrite stage S3. For example, the gypsum portion A is separated into a fraction A1 intended to be used, for example, as a recycled fraction in a plaster manufacturing process P, and a fraction A2 intended to be sent to the anhydrite stage S3.

Step S3 anhydrite includes heating the gypsum, preferably gently, to a temperature above 100° C. (degrees Celsius), to dehydrate it. The S3 anhydrite stage therefore consumes heat.

The recovering process according to the invention then comprises recovering at least some of the heat generated by the exothermic process during the gaseous fuel generation stage S2, and using this heat to heat the gypsum in the anhydrite stage S3.

According to one embodiment, the heat recovered from the S2 gaseous fuel generation stage is sufficient to heat the gypsum in the S3 anhydrite stage and achieve conversion to anhydrite, so that no additional heat input is required. In addition, after the gypsum has been heated, the remaining heat can be recovered for re-injection elsewhere in the recovery process and/or for storage and/or for conversion into electrical energy.

In one embodiment, step S3 anhydrite may comprise, after heating the gypsum, grinding the gypsum to a controlled particle size.

In one embodiment, the S3 anhydrite stage may comprise, after heating and, if necessary, grinding, packaging of the anhydrite, for example in bags.

The anhydrite obtained and packaged in this way can be marketed directly, particularly as an agricultural input.

In one embodiment, at least some of the gaseous fuel G produced in generation step S2 is sent to an energy generation step S4. This energy can take two forms: mechanical and thermal. On the one hand, gaseous fuel G can be used to obtain mechanical energy. To this end, for example, generation step S4 comprises introducing gaseous fuel G into a generator such as a gas engine, which may be coupled to an alternator to produce electrical energy. On the other hand, the heat from the gaseous fuel can be recovered at least in part as thermal energy. The gaseous fuel G produced may have a temperature of more than 400° C. at the outlet of the generation step S2, and in particular a temperature of between 500° C. and 700° C. Generation step S4 may therefore involve recovering the heat from gaseous fuel G and converting it into electrical energy using any known method.

In a particular embodiment, step S4 is a so-called co-generation step, in which both mechanical energy and thermal energy are generated. For example, before passing through a gas engine, the recovery process can include a pre-treatment stage for the gaseous fuel G, during which it is cooled and cleaned of any substances unsuitable for the gas engine. This means that heat can be recovered during the pre-treatment stage. The gas engine can also generate heat that needs to be recovered. Finally, the alternator coupled to the gas engine can in turn produce heat, which will be advantageously recovered.

More generally, heat can be recovered whenever it is available throughout the recovery process. Some or all of the thermal energy generated in this way can be fed back directly into the recovery process, for example to maintain the reactions in the gaseous fuel generation stage S2 or to heat the gypsum in the anhydrite stage S3. Alternatively, or in combination, the thermal energy can be used in whole or in part to produce electrical energy. Thus, according to one embodiment, at least the gaseous fuel generation stage S2, the anhydrite stage S3 and the energy generation stage S4 are self-sufficient in energy, i.e. no external energy input is required. Eventually, the entire recovery process is energy self-sufficient.

The electrical energy produced in this way can be sent to an electrical grid, for example in a town or city, or to the site of a facility implementing the recovery process in order to operate the various stations.

The recovery process thus enables maximum recovery of both the A portion of rejects and the B portion of gypsum from sorting and crushing stage S1, by converting them into energy and an input respectively, while limiting energy consumption. The advantageous use of the heat C produced during the step S2 of generating fuel G from the rejects B to treat a portion A2 of gypsum promotes a high level of recovery of the products of the recycling step S1.

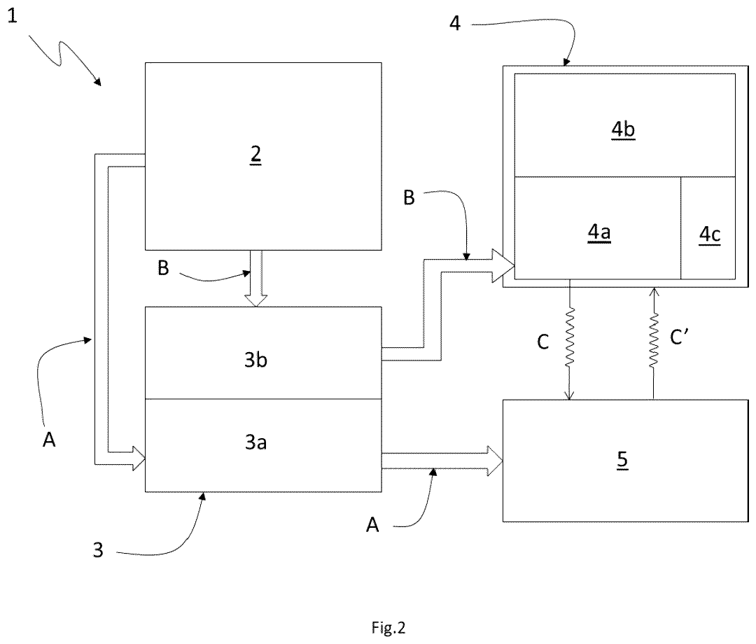

An example of a plant 1 for recovering plaster waste from the general public to implement the process described above will now be described with reference to FIG. 2.

According to this example, the installation 1 comprises a sorting station 2, in which the plaster waste undergoes one or more successive sorting operations, in order to obtain the portion A of gypsum and the reject portion B mentioned above. The sorting station 2 is, for example, a gypsum waste recycling station as known in the state of the art, which may include shredders and sieve-type sorting devices.

The plant 1 may then include a storage station 3, which comprises an area 3a for storing the gypsum portion A and an area 3b for storing the reject portion B.

A conveying system, not shown, is used to convey at least part of the reject portion B to a transformation station 4 for the generation of gaseous fuel G. The conversion station 4 can include a gasification zone 4a, a pre-treatment zone 4b and a co-generation zone 4c.

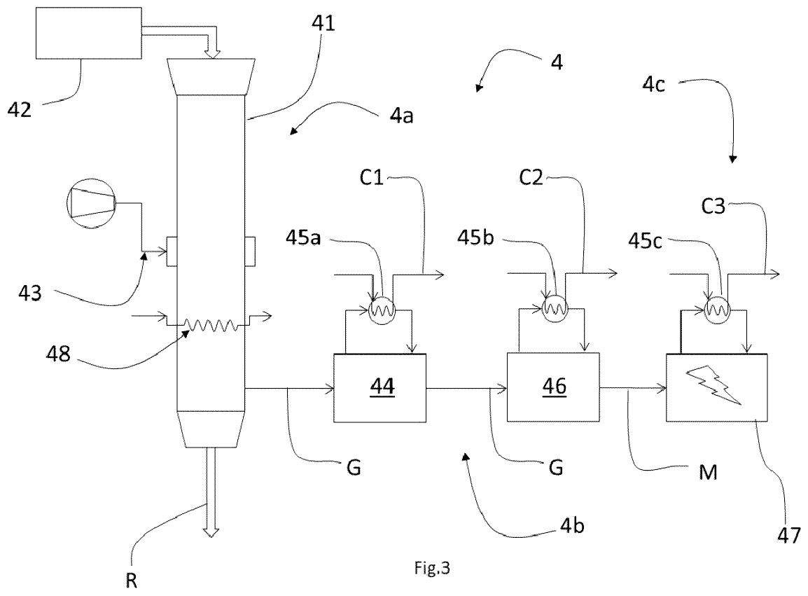

An example of the gasification zone 4a is shown in FIG. 3. According to this example, the gasification zone 4a comprises in particular a gasification reactor 41, fed from a hopper 42 for example with a reject portion B using a conveyor system not shown. The reactor 41 is, for example, of the co-current fixed bed type, with the materials moving vertically from an upper part of the reactor 41 to a lower part, and enables the phases of the gaseous fuel generation stage S2 as described above to be carried out, so that feed from the hopper 42 is from an upper part of the reactor 41. In particular, the reactor 41 can be equipped with hot gas inlets (not shown) for the drying and pyrolysis phases, as well as an air injector 43 to inject air for the oxidation phase. The residual solid phase R is recovered from the lower part of reactor 41, and can be considered as an end product. It is mainly ash. The gaseous fuel G produced is in turn recovered in the lower part of reactor 41.

The installation 1 may comprise several reactors 41 in which all the phases of the gaseous fuel generation stage S2 occur, or several separate and successive enclosures in which only some of the phases occur.

Any other type of reactor capable of producing fuel G can be installed as a replacement or in combination in the conversion station 4. In particular, the fuel G produced may be in a form other than gas.

According to the example shown, the gaseous fuel G leaving the reactor 41 is conveyed by any known means into the pre-treatment zone 4b, which comprises a pre-treatment device 44, during which the fuel G is cleaned and cooled, the heat being recovered in a first heat exchanger 45a, to recover a first fraction C1 of heat. The pre-treated gaseous fuel G is then fed into the electrical energy generator system. The electrical energy generating system includes a generator 46, for example a gas engine, where it is transformed into mechanical energy. A second heat exchanger 45b can be used to recover a second fraction C2 of the heat generated in the generator 46. The electrical energy generating system may further comprise an alternator 47 coupled to the generator 46, wherein the mechanical energy M produced is used to generate electrical energy in the co-generation zone 4c. A third heat exchanger 45c can be used to recover a third fraction C3 of the heat generated by the alternator 47.

The heat fractions C1, C2 and C3 recovered by heat exchangers 45a, 45b and 45c can be used to be re injected in part into reactor 41, or into any device in plant 1 or on the plant 1 site requiring a heat input, and in particular for the transformation of gypsum into anhydrite as will be explained below. Alternatively, or in combination, the recovered heat fractions C1, C2 and C3 can be converted into electrical energy.

The electrical energy produced can at least partly supply an electrical grid, for example that of the installation 1 or a city grid.

Finally, a fourth heat exchanger 48 recovers a fraction C4 of the heat produced by the exothermic process in reactor 41, for example during the oxidation phase.

Finally, plant 1 includes an anhydrite station 5, where gypsum portion A is conveyed by any known means in order to be transformed into anhydrite.

More specifically, the anhydrite station 5 comprises at least one heating device 50, which may for example be of the tube dryer type, and which converts the gypsum into anhydrite by heating it to a temperature of at least 100° C., preferably even more preferably at least 180° C., and at least ° C., and even more preferably at least 300° C. The temperature for transforming gypsum into anhydrite is controlled to obtain active anhydrite, which can be rehydrated. These are known as semi-hydrates. Below 300° C., the heat transforms the gypsum into anhydrite, which can be rehydrated for the most part. Above 300° C., rehydration is more difficult. Generally speaking, the higher the temperature, the more difficult it will be to rehydrate the anhydrite obtained. Above 450° C., rehydration is considered very difficult, if not impossible.

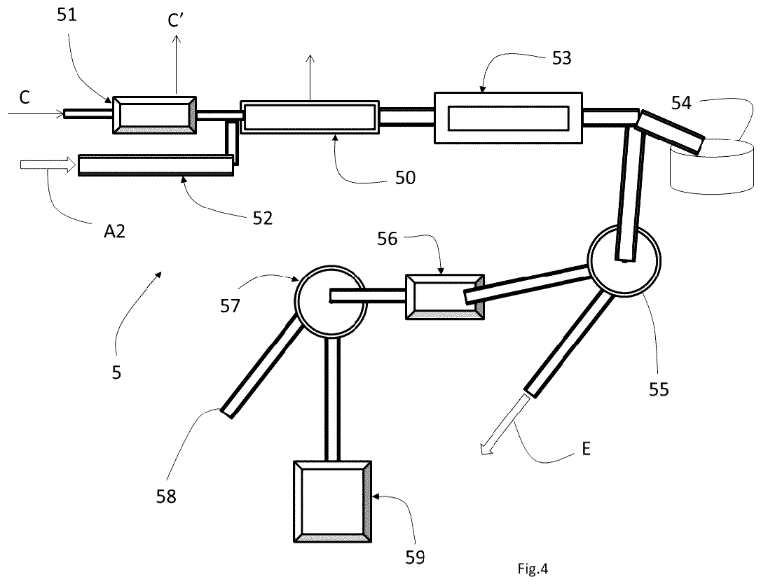

An example of anhydrite station 5 is shown in FIG. 4. The heating device 50 is supplied with heat from a heat exchange module 51, which uses at least some of the heat C produced during step S2 to generate gaseous fuel. For example, heat C corresponds to the sum of heat fractions C1, C2, C3 and C4 recovered in transformation station 4. Some of this heat is extracted in the heat exchange module 51 for use in the drying device 50; the remaining residual heat C′ can be recovered for use elsewhere in the recovery plant 1, for example in the processing station 4.

The anhydrite station 5 can include an inlet conveyor 52 for the gypsum fraction A2, which continuously feeds gypsum to the heating device 50. The heating device 50 is, for example, a dryer tube, in which the material advances between an inlet and an outlet at the same time as it is heated. The material leaving the heating device 50 is then anhydrite.

In one embodiment, the anhydrite leaving the heating device 50 is conveyed to a mill 53, for example a ball mill, which reduces the anhydrite to a powder with a particle size of less than 100 μm, for example.

Some of the anhydrite powder can be stored in a silo 54. Storage silo 54 provides a reserve of anhydrite for a variety of uses.

The other part of the anhydrite powder can be sent to a circular sieve 55. The circular sieve (55) is used to sort and separate any exogenous substances E present in the anhydrite powder, and also to calibrate the grains of anhydrite powder to a specific mesh size. The exogenous substances E can be recovered and returned to processing station 4.

The gypsum powder leaving the circular sieve 55 can then be sent to a press 56, which forms granules from the gypsum powder. The pellets leaving the press 56 can be stored in a storage module 57.

The anhydrite granules can then be taken in bulk directly from the storage module 57 via an outlet conveyor 58.

Alternatively, or in combination, the outlet of storage module 57 is connected to a packaging module 59 for bagging the granules.

Although it has not been described in every case, between the various devices in anhydrite station 5, conveyor belt-type conveyors are used to transport the material, continuously if necessary.

Thus, the anhydrite station 5 offers a complete and direct transformation of gypsum into anhydrite in one or more forms, enabling it to be marketed and therefore recovered. The anhydrite station 5 is associated with the transformation station 4 for fuel generation, so that no external energy input is required, the heat required by the anhydrite station 5 being supplied by the transformation station 4 for fuel generation.

The transformation station 4 for the generation of gaseous fuel G and the anhydrite station 5 are preferably located on a single site, maximising the use of the heat C produced during the gaseous fuel generation stage S2.

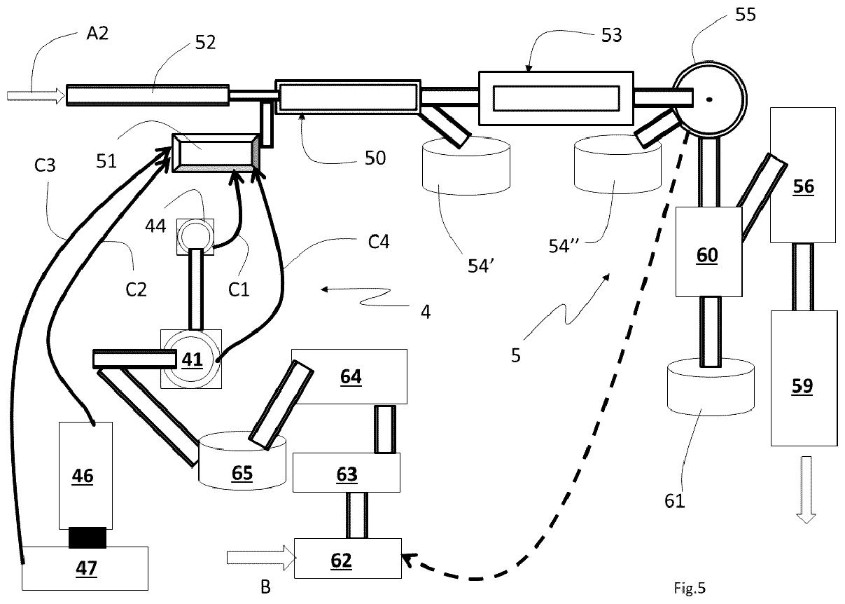

FIG. 5 shows an example of how stations 4 and 5 can be installed on the same site. In this example, as before, a portion A2 of gypsum is fed, preferably continuously, to a tube 50 dryer via a conveyor 52. The dryer tube 50 is associated with the heat exchange module 51 to use the recovered heat C to dry the gypsum and transform it into anhydrite. At the outlet of the dryer tube 50, some of the anhydrite can be stored in a silo 54′, while the other part is sent to the crusher 53. The crushed anhydrite is then passed through a circular 55 sieve. The silo 54 shown in FIG. 4, which is not shown here, can also be placed upstream of the sieve 55. On leaving the sieve 55, some of the ground anhydrite can be stored in a silo 54″, and the other part is sent to a mixing station 60, where it can be mixed with other components depending on the desired end product, for example magnesia and lime. Part of the mixture can be stored in a silo 61, and the other part can be sent to the press 56 to form granules, which are then bagged in the packaging module 59.

The presence of silos 54, 54′, 54″ and 61 means that gypsum can be recovered in different forms, so that production can be adjusted according to requirements.

The heat used in the dryer tube 50 comes from the transformation station 4 for the generation of fuel G. For this purpose, the rejects B can first be mixed with the rejects from the sieve 55 of the gypsum station 5 (dashed lines in FIG. 5) in a mixing station 62. Optionally, the mixture of reject B and reject from sieve 55 is prepared before feeding the reactor 41, in order to maximise the yield. For example, the mixture is pre-ground in a pre-grinding station 63 and then transformed into pellets in a pelletising station 64. A silo 65 between the pelletising station 64 and the reactor 41 can form a buffer zone. The mixture of rejects in the form of pellets comprising the rejects B from sorting stage S1 is then fed into reactor 41, as described above. The heat fractions C1, C2, C3 and C4 coming respectively from the pre-treatment device 44, the generator 46, the alternator 47 and the reactor 41 can all or partly supply the heat exchange module 51.

Any heat produced in a station of the installation can advantageously be recovered to be used to produce anhydrite and/or to produce electrical energy. For example, the press 56 and the pelletising station 64 can generate heat, for example by friction. This heat can advantageously be recovered by any known means, such as heat exchangers.

Even more preferably, the recovery plant 1 is located on a single site, so that all the stations 2, 3, 4 and 5 used to carry out steps S1, S2 and S3 are located on this single site.

1. A process for recycling plaster waste from the general public, the process comprising:
A stage for sorting solid waste in order to obtain at least one portion known as gypsum, comprising mainly gypsum, and a portion known as reject, comprising mainly any material other than gypsum, the reject portion comprising at least some organic matter;
A step of generating fuel from at least part of the portion of rejects by an exothermic process;
A step for generating anhydrite from at least part of the gypsum portion,
the process being characterised in that it further comprises the recovery of at least part of the heat generated by the exothermic process, in that the step of generating anhydrite comprises the heating of the at least part of the portion of gypsum, and in that the said heating is carried out from the at least part of the heat recovered during the generation of fuel in order to use it for the heating of the portion of gypsum.

2. A process according to claim 1, wherein the fuel generation step comprises a gasification step.

3. A method according to claim 1, in which at least some of the fuel is used in an electrical energy system to supply an electrical grid.

4. Process according to the preceding claim, in which at least part of the heat (C) recovered is used in the fuel generation step.

5. Process according to claim 1, in which the reject portion comprises at least in part paper or cardboard.

6. Process according to claim 1, in which the step of generating anhydrite comprises, after heating, grinding the anhydrite to a predetermined particle size.

7. Process according to claim 1 comprising the recovery of some of the residual heat remaining after the heating of the anhydrite generation stage

8. Installation for recovering plaster waste from the general public for implementing the process according to claim 1, the installation comprising:
at least one waste sorting station to obtain at least one gypsum portion comprising mainly gypsum, and a reject portion comprising mainly any material other than gypsum, the reject portion comprising at least some organic matter;
at least one conversion station for generating fuel from at least part of the reject portion by an exothermic process;
at least one anhydrite station for generating anhydrite from at least part of the gypsum portion
the installation being characterised in that the anhydrite station comprises at least one heating device and in that the installation further comprises at least one heat exchange module between the transformation station and the heating device

9. Installation according to claim 8, in which the transformation station comprises at least one gasification reactor

10. Installation according to claim 9, in which the at least one reactor is of the co-current fixed bed type.

11. Installation according to claim 8 in which the anhydrite station additionally comprises at least one grinder downstream of the heating device

12. Installation according to claim 8, in which the transformation station for fuel generation and the anhydrite station are located on the same site.
